(19) United States
(12) Patent Application Publication
(10) Pub. No.: US 2026/0002009 A1
(43) Pub. Date: Jan. 1, 2026

(54) SYSTEM AND METHOD FOR TREATMENT OF POLYMER WASTE

(71) Applicant: NESTE OYJ, ESPOO (FI)

(72) Inventors: Mika KETOMÄKI, PORVOO (FI); Olli SILTALA, PORVOO (FI); Eetu TUOHI, PORVOO (FI); Mika T KETTUNEN, PORVOO (FI); Perttu UOTILA, PORVOO (FI); Santeri KUOKKA, PORVOO (FI)

(21) Appl. No.: 18/992,466

(22) PCT Filed: Jun. 26, 2023
(86) PCT No.: PCT/FI2023/050386

§ 371 Date: Jan. 8, 2025

(30) Foreign Application Priority Data
Jul. 11, 2022 (EP) 22184071.3
Jul. 11, 2022 (FI) 20225656

(51) Int. Cl. C08J 11/12; C10B 47/30; C10B 53/07

(52) U.S. Cl. CPC C08J 11/12; C10B 47/30; C10B 53/07

(57) ABSTRACT

According to an example aspect of the present invention, there is provided a system (1) comprising a hollow chamber (2) comprising a first chamber (3) and a second chamber (4), wherein the second chamber (4) is rotatable or the first chamber (3) and the second chamber (4) are rotatable, a heating system (19) configured to heat the second chamber (4) or to individually heat the first chamber (3) and the second chamber (4), a lance (5) having at least one feed outlet (6), wherein the lance (5) extends within the hollow chamber (2) at least through the first chamber (3), and wherein the system (1) is configured to feed polymer waste (7) into the second chamber (4) via the at least one feed outlet (6), at least one injector (21) capable of injecting at least one sweep fluid into the first chamber (3) or into the first chamber (3) and into the second chamber (4) in order to form a fluid flow towards at least one gas outlet (20) for collecting a product (13) comprising the at least one sweep fluid and a gas (22) from at least partially pyrolyzed polymer waste.

### FIELD

The present invention relates to a system for treatment of polymer waste.

Further, the present invention relates to a method for treatment of polymer waste.

### BACKGROUND

Polymers are used in a wide variety of products. The polymers are typically acquired through petroleum resources, which are considered non-renewable. In this connection, the need for a sustainable supply of raw material has arisen, as accumulation of polymer waste has been recognized as an environmental problem. As a consequence, polymer waste is often collected and sorted for recycling or thermal decomposition purposes. Environmental problems can be reduced by subsequent polymer waste material treatment and re-use of at least a part of the material.

For example, polymer waste material can be treated by pyrolysis, i.e. by thermal decomposition of the polymer waste material at elevated temperatures in an inert atmosphere, in order to obtain a product comprising a gas from at least partially pyrolyzed polymer waste. Such treatment may, for example, take place in a reactor, such as a rotary kiln reactor, into which polymer waste is fed. Typically, a carrier gas is further utilized to promote a flow, increase a flow velocity and to flush the process train of a gas from at least partially pyrolyzed polymer waste towards another section for aftertreatment. Nitrogen is a commonly used carrier gas, for instance. Other examples of a carrier gas are carbon dioxide or methane.

In view of the above, it would be beneficial to provide a system and method for treatment of polymer waste.

### SUMMARY OF THE INVENTION

The invention is defined by the features of the independent claims. Some specific embodiments are defined in the dependent claims.

According to a first aspect of the present invention, there is provided a system comprising a hollow chamber comprising a first chamber and a second chamber, wherein the second chamber is rotatable or the first chamber and the second chamber are rotatable, a heating system configured to individually heat the second chamber or the first chamber and the second chamber, a lance having at least one feed outlet, wherein the lance extends within the hollow chamber at least through the first chamber, and wherein the system is configured to feed polymer waste into the second chamber via the at least one feed outlet, at least one injector capable of injecting at least one sweep fluid into the first chamber or into the first chamber and into the second chamber in order to form a fluid flow towards at least one gas outlet for collecting a product comprising the at least one sweep fluid and a gas from at least partially pyrolyzed polymer waste.

Various embodiments of the first aspect may comprise at least one feature from the following bulleted list:
the first chamber and the second chamber are individually rotatable,
the hollow chamber comprises a barrier between the first chamber and the second chamber, wherein an opening is provided between the barrier and the lance
the barrier is made of metal, a metal alloy, a high temperature resistant fabric or a combination thereof
the system comprises a compressor arranged downstream of the gas outlet
the hollow chamber is at least partially arranged within a housing comprising the heating system, wherein the heating system comprises a first space configured to receive a first heating gas having a first temperature and a second space configured to receive a second heating gas having a second temperature, wherein the first space is aligned with the first chamber and the second space is aligned with the second chamber,
the hollow chamber is at least partially arranged within a housing comprising the heating system, wherein the heating system comprises only the second space configured to receive the second heating gas having a second temperature, wherein the second space is aligned with the second chamber
the second space comprises a plurality of heating zones, wherein each heating zone is configured to receive a heating gas having a specific temperature
the system further comprises at least one movable object arranged within the first chamber
the system further comprises at least one structure protruding in the first chamber from an inner surface of the hollow chamber into the chamber
the system is configured to inject via the at least one injector at least one of: a condensable gas, steam, water, a non-condensable gas, nitrogen, or a hydrocarbon such as pyrolysis oil or diesel
the second chamber comprises at least one residue outlet
each of the first chamber and the second chamber comprises at least one residue outlet
the gas outlet is comprised either by the first chamber or the second chamber

According to a second aspect of the present invention, there is provided a method comprising providing a hollow chamber comprising a first chamber and a second chamber, wherein the second chamber is rotated or the first chamber and the second chamber are rotated, heating the second chamber or individually heating the first chamber and the second chamber, providing a lance having at least one feed outlet, wherein the lance extends within the hollow chamber at least through the first chamber, and feeding polymer waste into the second chamber via the at least one feed outlet, injecting at least one sweep fluid into the first chamber or into the first chamber and into the second chamber in order to form a fluid flow towards at least one gas outlet for collecting a product comprising the at least one sweep fluid and a gas from at least partially pyrolyzed polymer waste.

Various embodiments of the second aspect may comprise at least one feature from the following bulleted list:
the method further comprises individually rotating the first chamber and the second chamber
a wall temperature of the hollow chamber is in the first chamber and in the second chamber in a range between 500-800° C.
the method further comprises arranging the hollow chamber at least partially within a housing having a first space and a second space, receiving a first heating gas having a first temperature in the first space, wherein the first space is aligned with the first chamber, and receiving a second heating gas having a second temperature in the second space, wherein the second space is aligned with the second chamber
the method further comprises arranging the hollow chamber at least partially within a housing comprising the heating system, wherein the heating system comprises only the second space configured to receive the second heating gas having a second temperature, wherein the second space is aligned with the second chamber
the method further comprises individually heating a plurality of heating zones comprised by the second chamber, wherein each heating zone is configured to receive a heating gas having a specific temperature
the sweep fluid is at least one of: a condensable gas, steam, water, a non-condensable gas, nitrogen, or a hydrocarbon such as pyrolysis oil or diesel
a pressure gradient between the hollow chamber and the at least one gas outlet is in a range between 0.1-5 kPa, for example 0.5-2 kPa
the method further comprises pre-melting or extruding the polymer waste prior to feeding the polymer waste into the second chamber
the method further comprises liquifying the collected gas downstream of the gas outlet

Considerable advantages are obtained by certain embodiments of the invention. In particular, a system and method for treatment of polymer waste are provided. The system comprises a hollow chamber having a first chamber and a second chamber, wherein the second chamber is rotatable or the first chamber and the second chamber are rotatable. A sweep fluid can be injected into the first chamber and polymer waste material can be fed into the second chamber. A product comprising the at least one sweep fluid and a gas from at least partially pyrolyzed polymer waste is collected during operation of the reactor for aftertreatment. According to certain embodiments, a fluid flow is formed due to a pressure gradient between the first chamber and the second chamber, and thus a blowback of the gas from at least partially pyrolyzed polymer waste can be avoided. Use of a condensable gas, steam or water as a sweep fluid is beneficial for aftertreatment purposes, as the sweep fluid can be easily separated or removed from the product by condensation in the aftertreatment process. Removal of the sweep fluid or carrier gas not contributing to a liquid product yield in polymer waste pyrolysis can improve the recovery of hydrocarbons. Use of hydrocarbons or use of hydrocarbons containing water as a sweep fluid is beneficial for reducing the water content in the system, thus reducing the need for water separation and waste water management at a later stage. Maximizing the liquid product recovery is highly important for the techno-economic performance and sustainability of polymer waste pyrolysis processes. Additionally, the condensation train of a polymer waste material pyrolysis system is typically designed to remove pyrolytic water, and therefore feeding water or steam into the first chamber of the reactor does not bring significant additional complexity into the process.

### BRIEF DESCRIPTION OF THE DRAWINGS

FIG. 1 illustrates a schematic view of a system in accordance with at least some embodiments of the present invention,

FIG. 2 illustrates a schematic view of a heating system of a system in accordance with at least some embodiments of the present invention,

FIG. 3 illustrates a schematic view of another heating system in accordance with at least some embodiments of the present invention,

FIG. 4 illustrates a schematic view of a detail of a heating system in accordance with at least some embodiments of the present invention,

FIG. 5 illustrates a schematic view of a detail of a hollow chamber of a system in accordance with at least some embodiments of the present invention,

FIG. 6 illustrates a schematic view of a further detail of a hollow chamber of a system in accordance with at least some embodiments of the present invention,

FIG. 7 illustrates a schematic view of an even further detail of a hollow chamber of a system in accordance with at least some embodiments of the present invention,

FIG. 8 illustrates a schematic view of a yet further detail of a hollow chamber of a system in accordance with at least some embodiments of the present invention,

FIG. 9 illustrates a schematic view of a detail of a system in accordance with at least some embodiments of the present invention, and

FIG. 10 illustrates a schematic view of a system in accordance with at least some embodiments of the present invention.

### EMBODIMENTS

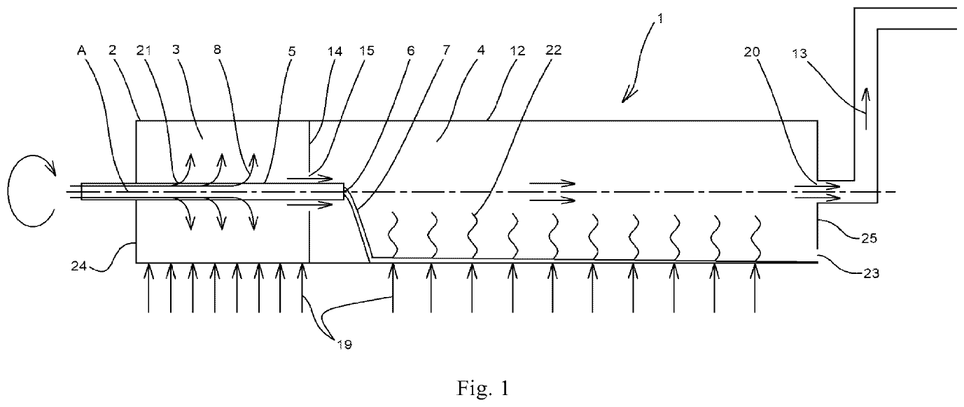

In FIG. 1 a schematic view of a system 1 in accordance with at least some embodiments of the present invention is illustrated. The system 1 comprises a so-called reactor or rotary kiln reactor, particularly for thermal decomposition of materials at elevated temperatures in presence of no or low amount of oxygen to avoid combustion of hydrocarbons. This process is also called pyrolysis.

Particularly, the system 1 comprises a hollow chamber 2 comprising a first chamber 3 and a second chamber 4. Both the first chamber and the second chamber are rotatable. The system 1 is configured to treat polymer waste 7. In this document, the term “polymer waste” relates to a material that comprises mainly a polymer material. For example, impurities in the polymer material may be present. Typically, the polymer waste 7 is material collected for recycling or thermal decomposition purposes. An example polymer waste feedstock used according to certain embodiments includes polyethylene with varying amounts of at least one of: polypropylene, polystyrene and other components such as polyamides, polyethylene terephthalate and polyvinyl chloride. Polymer waste feedstocks may be contaminated with minor traces of impurities that originate e.g. from biomass.

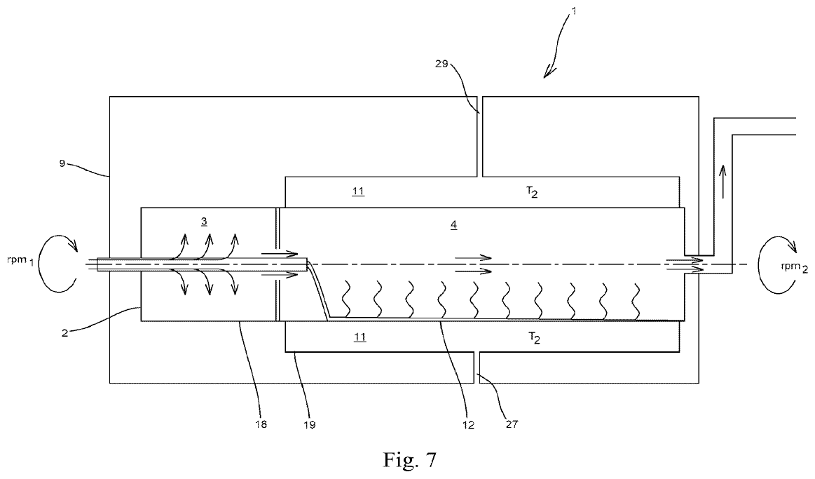

The hollow chamber 2 is typically in the form of an elongated hollow cylinder. The term “elongated” means that a length of the hollow cylinder is substantially greater than a diameter of the hollow cylinder. For example, the length of the hollow cylinder may be 18 m and the diameter of the hollow cylinder may be 2 m. The hollow chamber 2 is typically made of a metal or metal alloy. The entire hollow chamber 2 is configured to be rotated around an axis of rotation A. The axis of rotation A is typically orientated horizontally or substantially horizontally. The term “axis orientated horizontally” means an axis that is orientated perpendicular to a gravity vector or perpendicular to the normal on the surface of the Earth. Similarly, the term “axis orientated substantially horizontally” means an axis that is tilted a few degrees, for example less than 10 degrees, from the axis that is orientated perpendicular to a gravity vector or perpendicular to the normal on the surface of the Earth. The rotational speed of the entire hollow chamber 2 may be, for example, in the range between 0.1 and 5 revolutions per minute (rpm), for example in the range between 1 and 2 rpm. The first chamber 3 and the second chamber 4 rotate both simultaneously in the embodiment of FIG. 1. According to other embodiments, only the second chamber 4 is rotated or both the first chamber 3 and the second chamber are individually rotated as described in connection with FIG. 7.

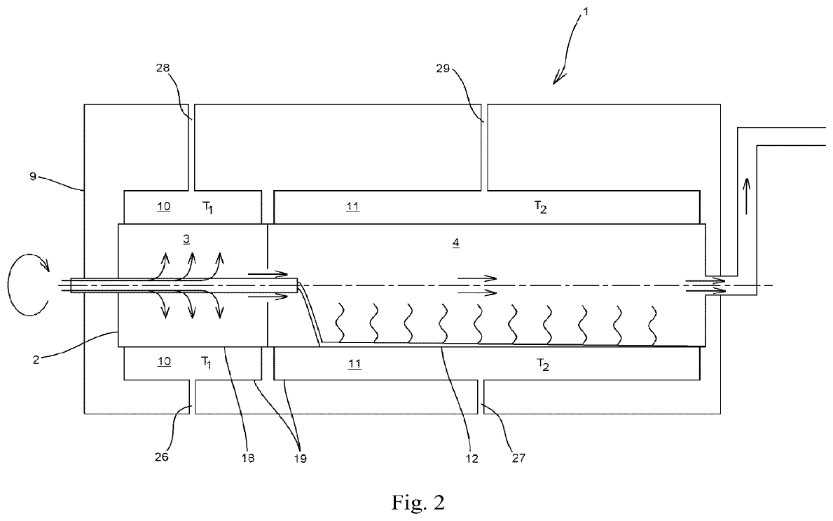

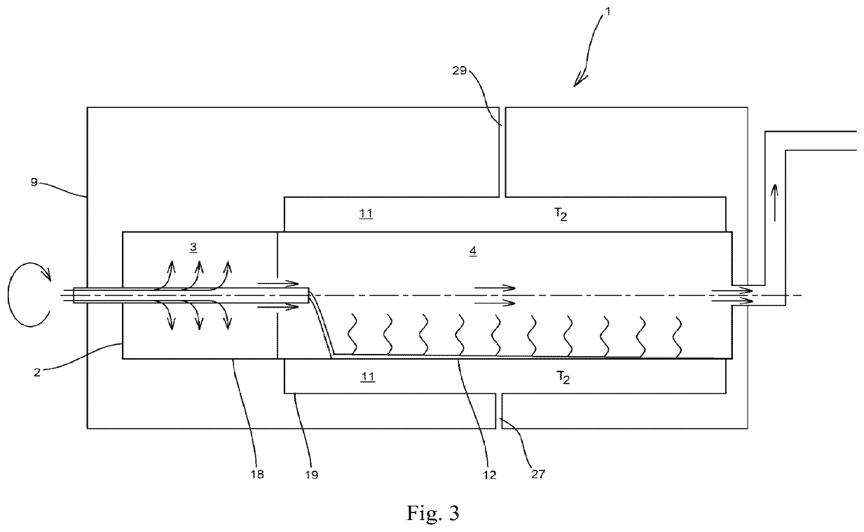

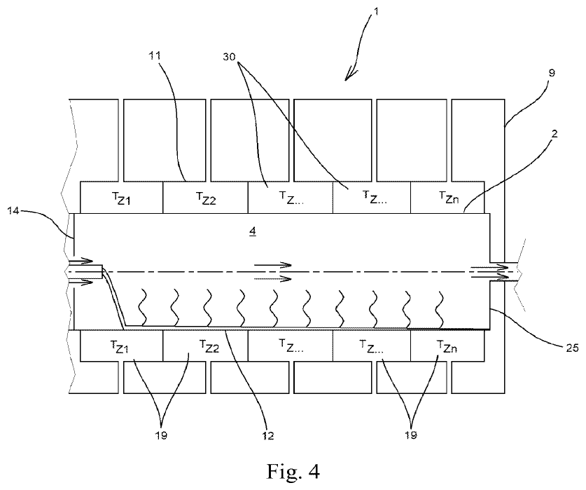

The system further comprises a heating system 19 configured to individually heat the first chamber 3 and the second chamber 4. The heating system 19 is typically arranged external to the walls of the hollow chamber 2 as indicated by arrows 19. Heating of the first chamber 3 and the second chamber 4 takes place by increasing a wall temperature of the rotatable hollow chamber 2 by contacting the wall with heating gas, in particular a lateral area of the rotatable hollow chamber, from ambient temperature to a temperature in the range between 200° C. and 800° C. Typically, the wall temperature in the lateral area of the first chamber 3 is different from the wall temperature in the lateral area of the second chamber 4. As a consequence, different temperatures can be provided within the first chamber 3 and within the second chamber 4, if required. The temperature within the first chamber 3 may be, for example, 550° C. and the temperature within the second chamber 4 may be, for example, 600° C. Typically, the temperature within the second chamber 4 is greater than the temperature within the first chamber 3. In other words, the system 1 is configured to adjust the temperature within the first chamber 3 and the temperature within the second chamber 4 by means of the heating system 19. The temperature within the second chamber 4 is typically greater than a decomposition temperature of a polymer waste material. An example of a heating system 19 for the shown embodiment is illustrated in FIG. 2. According to another embodiment of the present invention, only the second chamber 4 is heated as shown in FIG. 3. According to a further embodiment of the present invention, the wall of the second chamber 4 can be divided into sub-zones or heating zones which can be heated individually as shown in FIG. 4.

The system 1 yet further comprises a lance 5 having at least one feed outlet 6. The lance 5 is stationary, i.e. the lance 5 is not configured to rotate and the rotatable hollow chamber 2 is configured to rotate around the lance 5. The lance 5 may be, for example, in the form of a hollow cylinder. A center axis of the lance 5 is typically arranged or orientated coaxially with the axis of rotation A. The lance 5 is typically made of metal or a metal alloy. The lance 5 extends within the hollow chamber 2 at least through the first chamber 3. The lance 5 may additionally extend partially into the second chamber 4 as shown in FIG. 1. The system 1 is configured to feed polymer waste 7 into the second chamber 4 via the at least one feed outlet 6. The lance 5 is comprised by or coupled to a feeding system (not shown). The feeding system is typically an extrusion-type feeding system. The polymer waste 7 is (predominantly) pre-molten so that the feed is converted into a flowable form allowing travelling through the lance 5.

The polymer waste 7 material fed into the second chamber 4 via the at least one feed outlet 6 of the lance 5 falls on a heated inner surface 12 of the rotatable hollow chamber 2 due to gravity. The rotation of the hollow chamber 2 causes the polymer waste material 7 to distribute over at least a part of the inner surface 12 of the chamber 2 in the second chamber 4. Distribution of the polymer waste material 7 over at least a part of the inner surface 12 of the chamber 2 in the second chamber 4 may be improved by tilting the rotatable hollow chamber 2 a few degrees, for example 3 degrees to 5 degrees from the horizontal axis. In such a configuration, the rotatable hollow chamber 2 is arranged substantially horizontally.

The high temperature wall of the hollow chamber 2 causes thermal decomposition of the polymer waste material 7 within the second chamber 4, thus converting the polymer waste material 7 into a gas 22 from at least partially pyrolyzed polymer waste and a residue. The residue may comprise inorganics or inorganic contaminants, for instance. The rotatable hollow chamber 2 typically comprises a residue outlet 23 at a rear end 25 of the chamber 2.

The hollow chamber 2 further typically comprises a barrier 14 or seal between the first chamber 3 and the second chamber 4. The barrier 14 or seal is configured to allow a fluid flow, particularly a gas flow, from the first chamber 3 to the second chamber 4. For example, an opening 15 is provided between the barrier 14 and the lance 5. The opening 15 may be permeable for the sweep fluid to flow into the direction from the first chamber 3 into the second chamber 4, but impermeable into the opposite direction. The barrier 14 or seal may alternatively also comprise features allowing gas flow, i.a., a plurality of perforations, for instance. The barrier 14 is typically made of metal, a metal alloy or a high temperature resistant fabric.

The system 1 even further comprises at least one injector 21 capable of injecting at least one sweep fluid 8 into the first chamber 3. Within the embodiments shown in FIGS. 1-9, the term “injector” means a specific unit for injecting the at least one sweep fluid 8 into the first chamber 3. Such injector may, for example, comprise at least one sweep fluid injection lance extending into the first chamber 3. Such injector may, for example, comprise a nozzle. Alternatively, the term “injector” may also mean a simple opening in the system 1 through which the at least one sweep fluid 8 can be guided into the first chamber 3. The system 1 may also comprise a plurality of injectors 21, wherein each injector 21 is capable of injecting a different sweep fluid 8 into the first chamber 3. One injector 21 may be, for example, arranged to inject a condensable gas into the first chamber 3 and another injector 21 may be, for example, arranged to inject a non-condensable gas into the first chamber 3, such that the injection of sweep fluid is performed independently from each other with the respective use of condensable gas and non-condensable gas. In a preferred embodiment, steam as the condensable gas is being injected via cavity 31.

The plurality of injectors 21 may be, for example, each provided in the form of a separate sweep fluid injection lance. Such sweep fluid injection lances may be, for example, arranged around the feed lance 5. In such cases, a protective tube covering at least a part of the plurality of injection lances 21 and at least a part of the feed lance 5 may be further provided. As a consequence, various sweep fluids 8 may be guided through at least a part of the protective tube, but separately from the polymer waste feed. The protective tube as well as the feed lance 5 and the plurality of injection lances arranged within the protective tube are stationary, i.e. not configured to rotate. Openings may be further instead or in addition provided through the front end 24 of the hollow chamber 2 for guiding at least one sweep fluid 8 into the first chamber 3, for instance. The at least one injector 21 may be comprised by the lance 5 or independent from the lance 5.

A pressure gradient between the first chamber 3 and the second chamber 4 is generated so that a fluid flow, particularly a gas flow, is formed in a direction from the first chamber 3 to the second chamber 4, particularly towards a gas outlet 20. In other words, a sweep fluid is used to enhance the flow from the first chamber 3 to the second chamber 4. The pressure gradient further enhances the flow downstream towards an aftertreatment section (not shown). Injecting the sweep fluid 8 into the first chamber 3 causes the pressure in the first chamber 3 to increase so that the pressure in the first chamber 3 is greater than the pressure in the second chamber 4. The pressure gradient may be, for example, in the range between 0.1 and 5 kPa, for example in the range between 0.5 and 2 kPa. A mass flow of the sweep fluid through the at least one injector and/or a flow velocity may be adjustable in order to vary the pressure gradient. The pressure within the first chamber 3 and within the second chamber 4 can be monitored utilizing pressure sensors, respectively.

The sweep fluid 8 may be, for example, at least one of a condensable gas, steam, water, a non-condensable gas, nitrogen, a hydrocarbon, or diesel. As described above, also combinations of aforementioned sweep fluids 8 may be simultaneously injected into the first chamber 3. Water may be, for example, sprayed via at least one nozzle comprised by the at least one injector 21 into the first chamber 3 or directly on a heated inner surface of the wall of the hollow chamber 2 in the first chamber 3, thus causing the water spray to instantly vaporize and to generate steam in-situ inside the reactor, thus eliminating the need for a separate steam generating unit. The sweep fluid is then allowed to flow from the first chamber 3 into the second chamber 4, for example via opening 15. The fluid flow from the first chamber 3 into the second chamber 4 avoids a blowback of the gas 22 from at least partially pyrolyzed polymer waste. Use of a condensable gas, steam or water as a sweep fluid 8 is beneficial for aftertreatment purposes, when the sweep fluid 8 has to be separated from the product 13 at a later stage.

Additionally, the system comprises a gas outlet 20 arranged downstream of the at least one feed outlet 6 for collecting a product 13 comprising the at least one sweep fluid 8 and a gas 22 from at least partially pyrolyzed polymer waste.

According to certain embodiments, a compressor (not shown) may be optionally provided downstream of the gas outlet 20 for improving or assisting the flow of the product 13. The compressor may be also useful to keep the pressure within the first chamber 3 at a specific pressure, for example at atmospheric pressure, and to provide a pressure lower than the specific pressure within the second chamber 4. In other words, the pressure within the first chamber 3 and the second chamber 4 may be adjusted by injecting the sweep fluid 8 into the first zone 3 and utilizing the compressor. The compressor is capable of controlling the pressure in an area where the gas outlet 20 is located. The injection of sweep fluid 8 ensures that no air is entering the system 1 and is also used to ensure that a backflow is avoided and to reduce any possible disturbance in the gas flow. Since the system 1 may, for example, operate under slight vacuum, it is prone to having an air leak into the system 1. This could lead to combustion of hydrocarbons and result in fire and/or explosion. The combination of the compressor and the injection of sweep fluid 8 works as a system to provide guidance of pyrolysis gas towards the outlet 20. In case that the normal vacuum condition is lost, injection of sweep fluid 8 can prevent hydrocarbons from leaking out of the system 1.

Typically, a reduced pressure is provided at the location of the at least one gas outlet 20 to create a vacuum in order to remove the at least one sweep fluid 8 and the gas 22 from at least partially pyrolyzed polymer waste from the respective chambers 3, 4.

In FIG. 2 a schematic view of a heating system 19 of a system 1 in accordance with at least some embodiments of the present invention is illustrated. The hollow chamber 2 of FIG. 1 is arranged within a housing 9. The heating system 19 has a first space 10 configured to receive a first heating gas having a first temperature T₁. The first heating gas may be guided into the first space 10 via at least one first heating gas inlet 26 and guided out of the first space 10 via at least one first heating gas outlet 28. Further, the heating system 19 has a second space 11 configured to receive a second heating gas having a second temperature T₂. The second heating gas may be guided into the second space 11 via at least one second heating gas inlet 27 and guided out of the second space 11 via at least one second heating gas outlet 29. As can be seen, the first space 10 is aligned with or arranged adjacent to the first chamber 3 and the second space 11 is aligned with or arranged adjacent to the second chamber 4. The first space 10 may be in the form of a first heating chamber having a ring-like cross-section, for instance. The second space 11 may be in the form of a second heating chamber having a ring-like cross-section, for instance. The first heating gas and the second heating gas may be identical or different from each other. As a consequence, the first chamber 3 and the second chamber 4 can be individually heated by heating the wall 18 of the rotatable hollow chamber 2. The temperature of the wall 18 of the rotatable chamber 2 can be adjusted by varying the first temperature T₁ of the first heating gas and/or the second temperature T₂ of the second heating gas. The wall temperature of the hollow chamber 2 may be, for example, in the first chamber 3 and in the second chamber 4 in a range between 200° C. and 800° C. The temperature within the first chamber 3 and the second chamber 4 may be identical or different from each other. For example, the temperature within the first chamber 3 may be 600° C. and the second chamber 4 may be 550° C.

In FIG. 3 a schematic view of another heating system 19 in accordance with at least some embodiments of the present invention is illustrated. As can be seen, the heating system 19 is configured to only heat the second chamber 4. In such a configuration, it is not possible to spray water into the first chamber 3 as a sweep fluid. However, any sweep fluid in gaseous form may be injected into the first chamber 3. For example, steam generated by a steam generator may be injected into the first chamber 3 via the at least one injector.

In FIG. 4 a schematic view of a detail of a heating system 19 in accordance with at least some embodiments of the present invention is illustrated. As can be seen, the second space 11 comprises a plurality of heating zones 30, wherein each heating zone 30 is configured to receive a heating gas having a specific temperature T_{Z1}, . . . , T_{Zn}. The number of heating zones 30 can be any integer number greater than n=1. As a consequence, the heating zones 30 can be heated with different or identical temperatures T_{Z1}, . . . , T_{Zn}, for instance. the temperatures T_{Z1}, . . . , T_{Zn} are typically adjustable. For each heating zone 30 at least one heating gas inlet and at least one heating gas outlet are provided. Therefore, it is possible to heat each heating zone individually in order to generate a temperature gradient within areas of the second chamber 4. In other words, different thermo-zones are thus formed between adjacent areas within the second chamber due to the different heating zones 30. For example, a temperature may be greater within an area of the second chamber 4 in a direction upstream of the direction of flow of the sweep fluid 8. The concept of heating zones 30 may be incorporated into the heating system 19 as e.g. shown in FIG. 2 or FIG. 3, i.e. either into an embodiment having a heating system 19 comprising a first space 10 and a second space 11 or into an embodiment having a heating system 10 comprising only the second space 11.

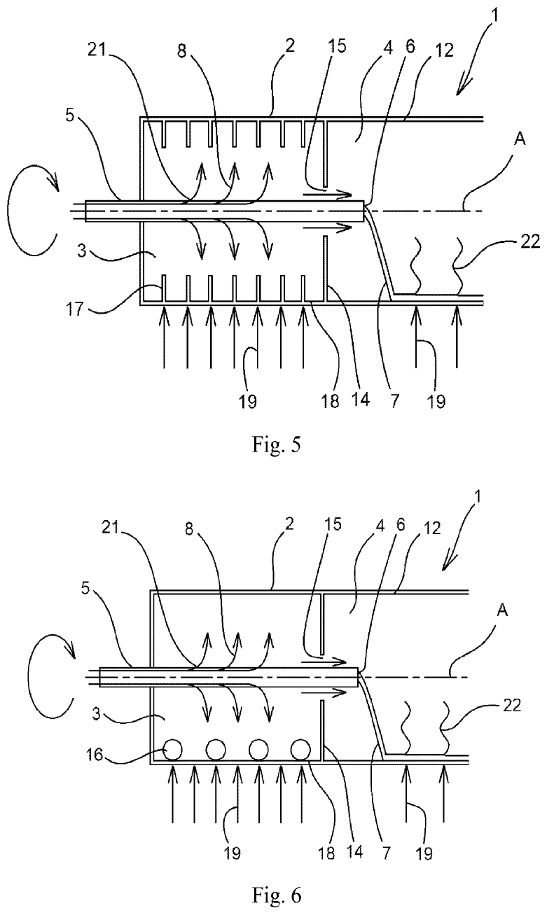

In FIG. 5 a schematic view of a detail of a hollow chamber 2 of a system 1 in accordance with at least some embodiments of the present invention is illustrated. The system 1 comprises at least one structure 17 protruding in the first chamber 3 from an inner surface 18 of the rotatable hollow chamber 2 into the chamber 2. The at least one structure 17 is a static or fixed structure. For example, a plurality of structures 17 in the form of plates may be arranged within the first chamber 3. The plurality of plates is particularly beneficial for heat exchange within the first chamber 3. Heat provided by the heating system 19 can be transferred into and distributed within the first chamber 3 of the hollow chamber 2 in order to quickly adjust or vary the temperature within the first chamber 3. The plurality of the at least one structure 17 is typically, but not necessarily, made of the same material as the hollow chamber 2. The material of the at least one structure has typically beneficial heat conducting properties.

In FIG. 6 a schematic view of a further detail of a rotatable hollow chamber 2 of a system 1 in accordance with at least some embodiments of the present invention is illustrated. The system 1 comprises at least one movable object 16 arranged within the first chamber 3 of the rotatable hollow chamber 2. For example, the at least one movable object 16 may be a steel ball rolling within the first chamber 3 during rotation of the hollow chamber 2. Instead or in addition, the movable object may be a chain, for instance. The at least one movable object 16 is typically, but not necessarily, made of the same material as the hollow chamber 2. The material of the at least one movable object 16 has typically beneficial heat conducting properties. A further benefit of the at least one movable object 16 lies in that the movable object 16 scrapes the inner surface 18 of the first chamber 3 during rotation of the hollow chamber 2 for cleaning purposes.

In FIG. 7 a schematic view of an even further detail of a hollow chamber 2 of a system 1 in accordance with at least some embodiments of the present invention is illustrated. According to the shown embodiment, the first chamber 3 and the second chamber 4 are rotated individually. In other words, the rotational speed of the first chamber 3 may be different from the rotational speed of the second chamber 4 as indicated by arrows rpm₁, rpm₂. The rotational speed of each of the first chamber 3 and the second chamber 4 may be, for example, in the range between 0.1 and 5 revolutions per minute (rpm), for example in the range between 1 and 2 rpm. However, both the first chamber 3 and the second chamber 4 or only the second chamber 4 may be heated as described above.

According to certain other embodiments, only the second chamber 4 is rotated and the first chamber 3 remains stationary. In such a configuration, there are no movable objects present within the first chamber 3 as described in connection with FIG. 6. However, both the first chamber 3 and the second chamber 4 or only the second chamber 4 may be heated as described above.

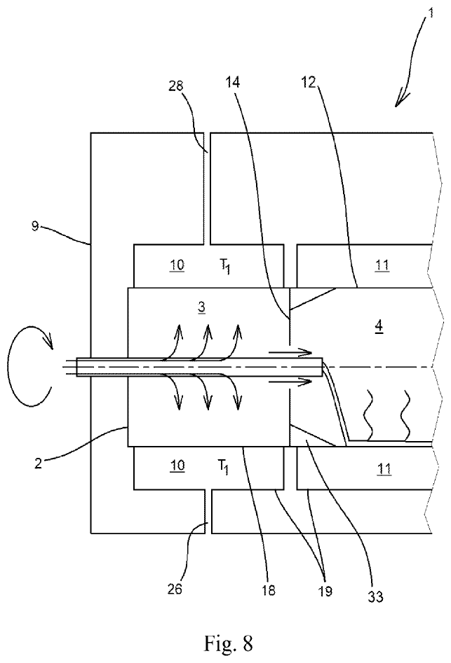

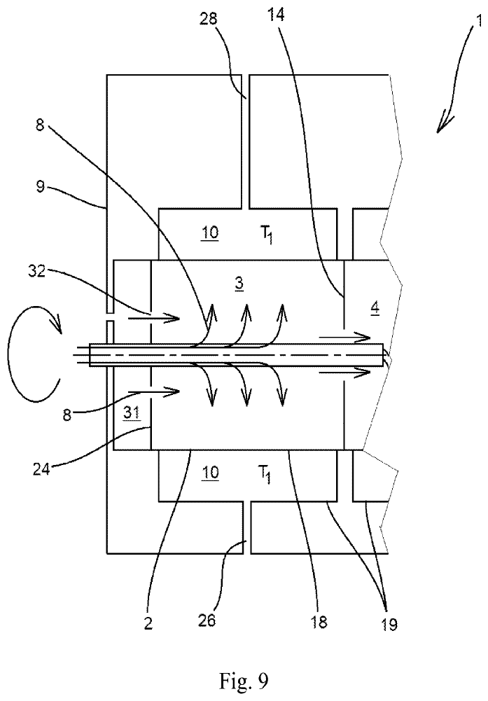

In FIG. 8 a schematic view of a yet further detail of a hollow chamber 2 of a system 1 in accordance with at least some embodiments of the present invention is illustrated. The inner wall surface 12 within the second chamber 4 may be partially conical in order to prevent plastic waste material from being distributed in a direction towards the barrier 14. The partially conical inner wall surface may be, for example, obtained by welding a hollow insert 33 having a conical inner surface to the barrier 14 and the inner wall of the hollow chamber 2 within the second chamber 4.

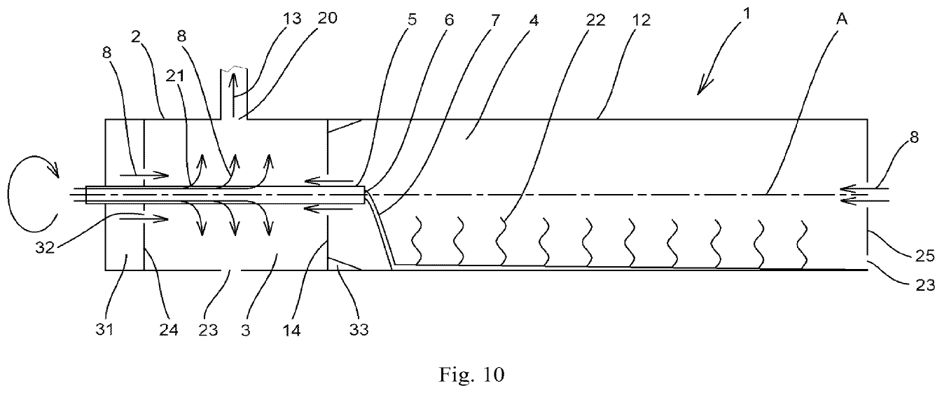

In FIG. 9 a schematic view of a detail of a system 1 in accordance with at least some embodiments of the present invention is illustrated. The housing 9 comprises a cavity 31 or space into which a sweep fluid 8 in gaseous form can be guided. A plurality of borings 32 is further provided through the front end 24 of the hollow chamber 2. Thus, the sweep fluid 8 in gaseous form can flow into the first chamber 3 through the borings 32. The sweep fluid 8 in gaseous form can be guided into the first chamber 3 in systems 1 having a stationary first chamber 3 or in systems 1 having either individually or simultaneously rotating first and second chambers 3, 4. The cavity 31 as such is not being rotated. In other words, the detail shown in FIG. 9 represents an injector 21 for injecting a sweep fluid 8 into the first chamber 3. One or more other sweep fluids 8 may be additionally injected into the first chamber 3, for example by utilizing one or more sweep fluid lances as described above.

In FIG. 10 a schematic view of a system 1 in accordance with at least some embodiments of the present invention is illustrated. The system 1 comprises a so-called reactor or rotary kiln reactor, particularly for thermal decomposition of materials at elevated temperatures in presence of no or low amount of oxygen to avoid combustion of hydrocarbons. This process is also called pyrolysis.

The operating principle of the shown embodiment differs from the operating principle of the embodiments shown in FIGS. 1-9. Particularly, at least one sweep fluid 8 is injected into both the first chamber 3 and the second chamber 4, both comprised by a hollow chamber 2.

The hollow chamber 2 is typically in the form of an elongated hollow cylinder. The term “elongated” means that a length of the hollow cylinder is substantially greater than a diameter of the hollow cylinder. For example, the length of the hollow cylinder may be 18 m and the diameter of the hollow cylinder may be 2 m. The hollow chamber 2 is typically made of a metal or metal alloy. At least the second chamber 4 is configured to be rotated around an axis of rotation A. The axis of rotation A is typically orientated horizontally or substantially horizontally. The term “axis orientated horizontally” means an axis that is orientated perpendicular to a gravity vector or perpendicular to the normal on the surface of the Earth. Similarly, the term “axis orientated substantially horizontally” means an axis that is tilted a few degrees, for example less than 10 degrees, from the axis that is orientated perpendicular to a gravity vector or perpendicular to the normal on the surface of the Earth. Only the second chamber 4 may be configured to rotate in the shown embodiment of FIG. 10. According to other embodiments, both the first chamber 3 and the second chamber 4 are simultaneously rotated as disclosed in connection with FIG. 1 or both the first chamber 3 and the second chamber are individually rotated as described in connection with FIG. 7. The rotational speed of the first chamber 3 and/or the second chamber 4 may be, for example, in the range between 0.1 and 5 revolutions per minute (rpm), for example in the range between 1 and 2 rpm.

The system further comprises a heating system (not shown) as described above in connection with any one of FIGS. 1-4. i.e., both the first and the second chamber 3, 4 are heated individually or only the second chamber 4 is heated. It may be further possible to heat heating zones of the second chamber 4 individually in order to generate a temperature gradient within areas of the second chamber 4.

The system 1 yet further comprises a lance 5 having at least one feed outlet 6. The lance 5 is stationary, i.e. the lance 5 is not configured to rotate and at least a part of the hollow chamber 2 is configured to rotate around the lance 5. The lance 5 may be, for example, in the form of a hollow cylinder. A center axis of the lance 5 is typically arranged or orientated coaxially with the axis of rotation A. The lance 5 is typically made of metal or a metal alloy. The lance 5 extends within the hollow chamber 2 at least through the first chamber 3. The lance 5 may additionally extend partially into the second chamber 4 as shown in FIG. 10. The system 1 is configured to feed polymer waste 7 into the second chamber 4 via the at least one feed outlet 6. The lance 5 is comprised by or coupled to a feeding system (not shown). The feeding system is typically an extrusion-type feeding system. The polymer waste 7 is (predominantly) pre-molten so that the feed is converted into a flowable form allowing travelling through the lance 5.

The polymer waste 7 material fed into the second chamber 4 via the at least one feed outlet 6 of the lance 5 falls on a heated inner surface 12 of the second chamber 4 due to gravity. The rotation of the second chamber 4 causes the polymer waste material 7 to distribute over at least a part of the inner surface 12 of the second chamber 4. Distribution of the polymer waste material 7 over at least a part of the inner surface 12 of the second chamber 4 may be improved by tilting the rotatable hollow chamber 2 a few degrees, for example 3 degrees to 5 degrees from the horizontal axis. In such a configuration, the rotatable hollow chamber 2 is arranged substantially horizontally.

The high temperature wall of the hollow chamber 2 causes thermal decomposition of the polymer waste material 7 within the second chamber 4, thus converting the polymer waste material 7 into a gas 22 from at least partially pyrolyzed polymer waste and a residue. The residue may comprise inorganics or inorganic contaminants, for instance. The shown hollow chamber 2 comprises a residue outlet 23 for the first chamber 3 and further another residue outlet 23 for the second chamber 4.

The hollow chamber 2 further typically comprises a barrier 14 or seal between the first chamber 3 and the second chamber 4. The barrier 14 or seal is configured to allow a fluid flow, particularly a gas flow, from the second chamber 4 to the first chamber 3. For example, an opening 15 is provided between the barrier 14 and the lance 5. The opening 15 may be permeable for the sweep fluid 8 and the gas 22 to flow into the direction from the second chamber 4 into the first chamber 3, but impermeable into the opposite direction. The barrier 14 or seal may alternatively also comprise features allowing gas flow, i.e., a plurality of perforations, for instance. The barrier 14 is typically made of metal, a metal alloy or a high temperature resistant fabric.

The shown system 1 even further comprises a plurality of injectors 21 capable of injecting at least one sweep fluid 8 into the first chamber 3 and additionally into the second chamber 4. In other words, the system 1 comprises, within a housing (not shown), a cavity 31 or space into which a sweep fluid 8 in gaseous form can be guided. The cavity 31, as a part of the housing, is stationary. A plurality of borings 32 is further provided through the front end 24 of the hollow chamber 2. Thus, a sweep fluid 8 in gaseous form can flow into the first chamber 3 through the borings 32. The sweep fluid 8 in gaseous form can be guided into the first chamber 3 in systems 1 having a stationary first chamber 3 or in systems 1 having either individually or simultaneously rotating first and second chambers 3, 4. In other words, the cavity 31 shown in FIG. 10 represents an injector 21 for injecting a sweep fluid 8 into the first chamber 3. One or more identical or other sweep fluid 8 may be additionally injected into the first chamber 3, for example by utilizing one or more sweep fluid lances as described above. Further, an identical or another sweep fluid 8 is injected into the second chamber 4 as shown in FIG. 10. Injection of a sweep fluid 8 into the second chamber 4 typically takes place through a rear end 25 of the hollow chamber 2. For example, at least one further injection lance may be provided and/or another cavity or space into which a sweep fluid 8 in gaseous form can be guided may be provided, i.e. similar to the front end of the reactor.

Within the embodiment of FIG. 10, the term “injector” means a specific unit for injecting the at least one sweep fluid 8 into the first chamber 3 or into the second chamber 4. Such injector may, for example, comprise at least one sweep fluid injection lance extending into the first chamber 3 or into the second chamber 4. Such injector may, for example, comprise a nozzle. Alternatively, the term “injector” may also mean a simple opening in the system 1 through which the at least one sweep fluid 8 can be guided into the first chamber 3. The system 1 may also comprise a plurality of injectors 21, wherein each injector 21 is capable of injecting a different sweep fluid 8 into the first chamber 3 or into the second chamber 4. One injector 21 may be, for example, arranged to inject a condensable gas into the first chamber 3 or into the second chamber 4 and another injector 21 may be, for example, arranged to inject a non-condensable gas into the first chamber 3 or into the second chamber 4. The plurality of injectors 21 may be, for example, each provided in the form of a separate sweep fluid injection lance. Such sweep fluid injection lances may be, for example, arranged around the feed lance 5. In such cases, a protective tube covering at least a part of the plurality of injection lances 21 and at least a part of the feed lance 5 may be further provided. As a consequence, various sweep fluids 8 may be guided through at least a part of the protective tube, but separately from the polymer waste feed. The protective tube as well as the feed lance 5 and the plurality of injection lances arranged within the protective tube are stationary, i.e. not configured to rotate. Openings 32 may be further instead or in addition provided through the front end 24 of the hollow chamber 2 for guiding at least one sweep fluid 8 into the first chamber 3 and/or through the rear end 25 of the hollow chamber 2 for guiding at least one sweep fluid 8 into the second chamber 4, for instance. The at least one injector 21 may be comprised by the lance 5 or independent from the lance 5. A mass flow of the sweep fluid through the at least one injector and/or a flow velocity may be adjustable. The pressure within the first chamber 3 and within the second chamber 4 can be monitored utilizing pressure sensors, respectively.

The sweep fluid 8 may be, for example, at least one of a condensable gas, steam, water, a non-condensable gas, nitrogen, a hydrocarbon, or diesel. As described above, also combinations of aforementioned sweep fluids 8 may be simultaneously injected into the first chamber 3 and into the second chamber 4. Water may be, for example, sprayed via at least one nozzle comprised by the at least one injector 21 into the first chamber 3 or directly on a heated inner surface of the wall of the hollow chamber 2 in the first chamber 3, thus causing the water spray to instantly vaporize and to generate steam in-situ inside the reactor, thus eliminating the need for a separate steam generating unit. The sweep fluid is then allowed to flow towards the gas outlet 20. The fluid flow from the cavity 31 into the first chamber 3 avoids a blowback of the gas 22 from at least partially pyrolyzed polymer waste. Thus, the cavity 31 remains free of solid material particles carried towards the gas outlet 20. Use of a condensable gas, steam or water as a sweep fluid 8 is beneficial for aftertreatment purposes, when the sweep fluid 8 has to be separated from the product 13 at a later stage.

Additionally, the system 1 comprises the gas outlet 20 comprised by the first chamber 3 for collecting a product 13 comprising the at least one sweep fluid 8 and a gas 22 from at least partially pyrolyzed polymer waste. By providing the gas outlet 20 in the first chamber 3, i.e. away from the second chamber 4, the content of solid material in the form of lightweight particles or dust carried by the product 13 can be decreased. A pressure gradient between the hollow chamber 2 and the at least one gas outlet 20 is typically in a range between 0.1-5 kPa, for example 0.5-2 kPa. Typically, a reduced pressure is provided at the location of the at least one gas outlet 20, for example by utilizing a compressor, to create a vacuum in order to remove the at least one sweep fluid 8 and the gas 22 from at least partially pyrolyzed polymer waste from the respective chambers 3, 4.

The inner wall surface 12 within the second chamber 4 may be partially conical in order to prevent plastic waste material from being distributed in a direction towards the barrier 14. The partially conical inner wall surface may be, for example, obtained by welding a hollow insert 33 having a conical inner surface to the barrier 14 and the inner wall of the hollow chamber 2 within the second chamber 4.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in treatment of polymer waste.

### REFERENCE SIGNS LIST

1 system
2 hollow chamber
3 first chamber
4 second chamber
5 lance
6 feed outlet
7 polymer waste
8 sweep fluid
9 housing
10 first space
11 second space
12 inner surface of hollow chamber in second chamber
13 product
14 barrier
15 opening
16 movable object
17 structure
18 inner surface of hollow chamber
19 heating system
20 gas outlet
21 injector
22 gas
23 residue outlet
24 front end
25 rear end
26 first heating gas inlet
27 second heating gas inlet
28 first heating gas outlet
29 second heating gas outlet
30 heating zone
31 cavity
32 boring
33 insert
A axis of rotation

1. A system comprising:
a hollow chamber comprising a first chamber and a second chamber, wherein the second chamber is rotatable or the first chamber and the second chamber are rotatable,
a heating system configured to heat the second chamber or to individually heat the first chamber and the second chamber,
a lance having at least one feed outlet, wherein the lance extends within the hollow chamber at least through the first chamber, and wherein the system is configured to feed polymer waste into the second chamber via the at least one feed outlet, and
at least one injector capable of injecting at least one sweep fluid into the first chamber or into the first chamber and into the second chamber in order to form a fluid flow towards at least one gas outlet for collecting a product comprising the at least one sweep fluid and a gas from at least partially pyrolyzed polymer waste.

2. The system according to claim 1, wherein the hollow chamber comprises a barrier between the first chamber and the second chamber, wherein an opening is provided between the barrier and the lance.

3. The system according to claim 1, wherein the system comprises a compressor arranged downstream of the gas outlet.

4. The system according to claim 1, wherein the hollow chamber is at least partially arranged within a housing comprising the heating system, wherein the heating system comprises
a first space configured to receive a first heating gas having a first temperature and a second space configured to receive a second heating gas having a second temperature, wherein the first space is aligned with the first chamber and the second space is aligned with the second chamber, or
only the second space configured to receive the second heating gas having a second temperature, wherein the second space is aligned with the second chamber.

5. The system according to claim 4, wherein the second space comprises a plurality of heating zones, wherein each heating zone is configured to receive a heating gas having a specific temperature.

6. The system according to claim 1, wherein the system further comprises at least one movable object arranged within the first chamber.

7. The system according to claim 1, wherein the system further comprises at least one structure protruding in the first chamber from an inner surface of the hollow chamber into the chamber.

8. The system according to claim 1, wherein the system is configured to inject via the at least one injector at least one of:
a condensable gas,
steam,
water,
a non-condensable gas,
nitrogen, or
a hydrocarbon such as a pyrolysis oil or diesel.

9. The system according to claim 1, wherein the gas outlet is comprised either by the first chamber or the second chamber.

10. A method comprising:
providing a hollow chamber comprising a first chamber and a second chamber, wherein the second chamber is rotated or the first chamber and the second chamber are rotated,
heating the second chamber or individually heating the first chamber and the second chamber,
providing a lance having at least one feed outlet, wherein the lance extends within the hollow chamber at least through the first chamber, and feeding polymer waste into the second chamber via the at least one feed outlet,
injecting at least one sweep fluid into the first chamber or into the first chamber and into the second chamber in order to form a fluid flow towards at least one gas outlet for collecting a product comprising the at least one sweep fluid and a gas from at least partially pyrolyzed polymer waste.

11. The method according to claim 10, wherein a wall temperature of the hollow chamber is in the first chamber and in the second chamber in a range between 500-800° C.

12. The method according to claim 10, wherein the method further comprises:
arranging the hollow chamber at least partially within a housing having a first space and a second space,
receiving a first heating gas having a first temperature in the first space, wherein the first space is aligned with the first chamber, and
receiving a second heating gas having a second temperature in the second space, wherein the second space is aligned with the second chamber.

13. The method according to claim 10, wherein the sweep fluid is at least one of:
a condensable gas,
steam,
water,
a non-condensable gas,
nitrogen,
a hydrocarbon such as a pyrolysis oil or diesel

14. The method according to claim 10, wherein a pressure gradient between the hollow chamber and the at least one gas outlet is in a range between 0.1-5 kPa.

15. The method according to claim 10, the method further comprising:
pre-melting or extruding the polymer waste prior to feeding the polymer waste into the second chamber.

16. The method according to claim 10, the method further comprising:
liquifying the collected gas downstream of the gas outlet.
